(19) United States
(12) Patent Application Publication
(10) Pub. No.: US 2003/0120580 A1
(43) Pub. Date: Jun. 26, 2003

(54) Processing system for market efficiency value added

(75) Inventors: Yuichi Ikeda, Mito (JP); Kazuo Abe, Tokyo (JP); Masateru Hayashihara, Musashino (JP); Genichiro Ichihari, Tokyo (JP); Hiroshi Sakui, Abiko (JP)

Correspondence Address: McDermott, Will & Emery, 600 13th Street, N.W., Washington, DC, 20005-3096, US

(73) Assignee: HITACHI, LTD., Tokyo (JP)

(21) Appl. No.: 10/364,316

(22) Filed: Feb. 12, 2003

Related U.S. Application Data
(63) Continuation of application No. 10/307,425, filed on Dec. 2, 2002.

(30) Foreign Application Priority Data
Dec. 3, 2001 (JP) 2001-368082

(51) Int. Cl. G06F 17/60

(52) U.S. Cl. 705/36

(57) ABSTRACT

The object of the present invention is to provide a market efficiency value added (MEVA) for appropriately evaluating an operating department of an enterprise or a new business to be started. The present invention causes a computer to perform the operations of: obtaining a capital composition by use of a bankruptcy probability based on a distribution of ratios of earnings to amounts of invested money; obtaining a capital cost ratio based on the capital composition, a debt cost, and a shareholders' equity cost; and obtaining an MEVA from the capital cost ratio based on an after-tax operating profit; whereby the present invention sets an MEVA evaluation period to indicates an MEVA based on an after-tax operating profit of each business operation.

### BACKGROUND OF THE INVENTION

The present invention relates to a processing system and a processing method for providing a market efficiency value added (MEVA) used to evaluate an operating department of an enterprise or a new business to be started.

Recently, the severity of the circumstances surrounding enterprises has become higher, making it important to properly evaluate each business of an enterprise or the future of a new business in order to meet the needs of the shareholders, employees, and the society.

Even though various evaluation methods have been devised and put in practical use to determine a market efficiency value added, it is still necessary to develop a processing system capable of providing a more appropriate market efficiency value added for evaluation.

An object of the present invention is to provide a processing system capable of providing a more appropriate market efficiency value added for evaluation.

The other objects of the present invention will be described in the following description of the preferred embodiments.

### SUMMARY OF THE INVENTION

The present invention is characterized in that it obtains a capital composition based on a distribution with respect to profit to calculate a market efficiency value added (MEVA).

### BRIEF DESCRIPTION OF THE DRAWINGS

FIG. 1 is a system flowchart showing a management index processing system according to an embodiment of the present invention;

FIG. 2 is a diagram showing business risk (return distribution);

FIG. 3 is a diagram showing each combination of a rating, a bankruptcy probability, and a debt cost;

FIG. 4 is a diagram used for obtaining a share price risk β;

FIG. 5 is a diagram used for calculating a shareholders' equity cost (Re);

FIG. 6 is a processing flowchart for preparing a management index which is used to determine whether to invest in a new business and to which a management index processing system according to an embodiment of the present invention is applied;

FIG. 7 is a diagram showing a project analysis message screen;

FIG. 8 is a diagram showing an error database creation message screen;

FIG. 9 is a diagram showing a display screen displayed after a computer is activated;

FIG. 10 is a diagram showing an NOPAT (net operating profit after tax)-to-invested-capital ratio database;

FIG. 11 is a diagram showing a processing screen for the regression analysis shown in FIG. 8;

FIG. 12 is a diagram showing an estimation error graph;

FIG. 13 is a diagram showing a frequency distribution of estimation errors δ obtained based on a condition specified by the classification factor “asset scale”;

FIG. 14 is a diagram showing a frequency distribution of estimation errors δ obtained based on a condition specified by the classification factor “profitability”;

FIG. 15 is a diagram showing a frequency distribution of estimation errors δ obtained based on a condition specified by the classification factor “business type”;

FIG. 16 is a diagram showing a frequency distribution of estimation errors δ for a risk evaluation matrix;

FIG. 17 is a diagram showing a business plan input message screen made up of balance sheets;

FIG. 18 is a diagram showing a business plan input message screen made up of income statements;

FIG. 19 is a diagram showing an input screen for business plan input items;

FIG. 20 is an NOPAT (net operating profit after tax) distribution curve;

FIG. 21 is a diagram showing an ROI distribution curve;

FIG. 22 is a diagram showing an MEVA distribution curve;

FIG. 23 is a diagram showing an MEVA probability distribution curve;

FIG. 24 is a diagram showing an investment decision display menu message screen;

FIG. 25 is a diagram showing an MEVA and economic capital investment decision message screen;

FIG. 26 is a diagram showing a risk-adjusted earning rate investment decision message screen;

FIG. 27 is a diagram showing the single-year MEVA or accumulated MEVA for each year;

FIG. 28 is a diagram showing a frequency distribution of estimation errors δ obtained based on a condition specified by the classification factor “asset scale”;

FIG. 29 is a diagram showing a frequency distribution of estimation errors δ obtained based on a condition specified by the classification factor “profitability”; and

FIG. 30 is a diagram showing a frequency distribution of estimation errors δ obtained based on a condition specified by the classification factor “business type”.

### DESCRIPTION OF THE PREFERRED EMBODIMENTS

A processing system of the present invention for providing a market efficiency value added can be applied to processing systems which provide an added value for determining whether to invest in a new business or determining the efficiency and the “degree of activity” of each existing operating department of an enterprise.

The processing system according to the present invention for providing an MEVA (Market Efficiency Value Added) calculates an MEVA from a capital cost ratio calculated based on a required capital composition which is obtained from changes in earnings.

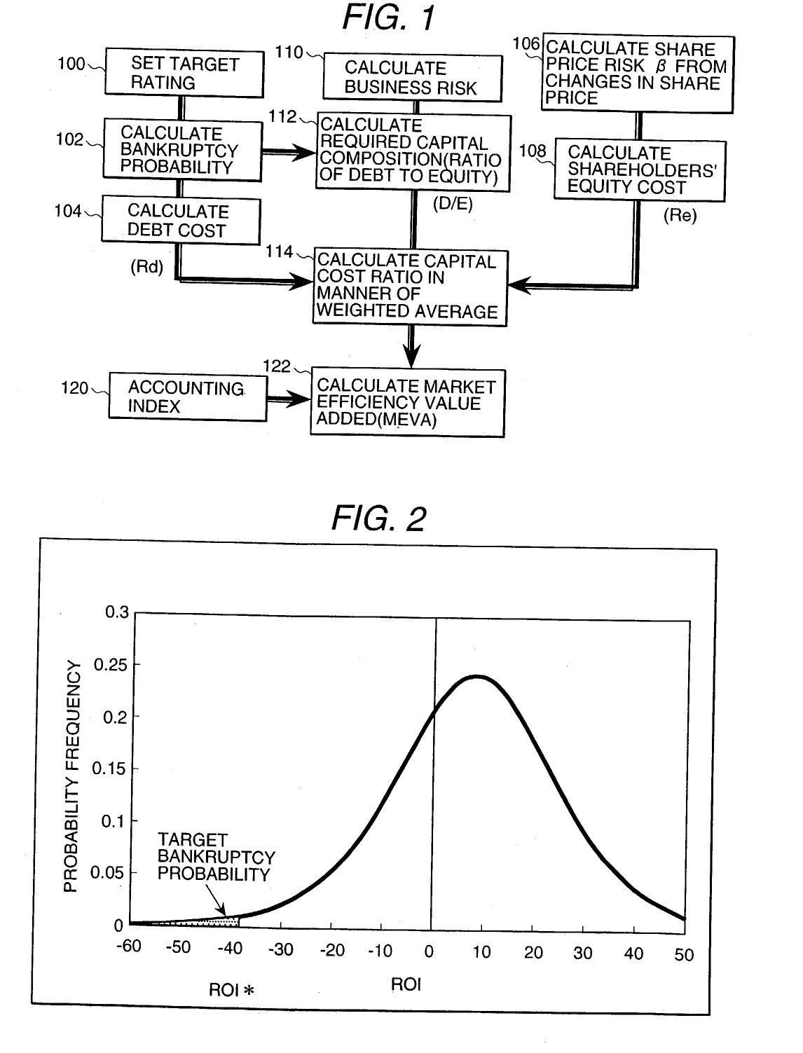

FIG. 1 is a system processing flowchart executed by a computer to implement a processing system for a market efficiency value added (MEVA) according to an embodiment of the present invention.

The present embodiment employs the steps of: analyzing past financial data of all operating departments within a company to prepare estimation errors in after-tax net operating profit; entering the financial data of a selected operating department of the company; based on the estimation errors and the financial data of the selected operating department of the company, evaluating the value of the selected operating department of the company; and evaluating a business value of the selected operating department of the company based on a given criterion to make a business investment decision; whereby the present embodiment provides a method for appropriately displaying calculated MEVA values which make it possible to: vitalize operations within the company; determine investment or withdrawal for each operating department; concentrate on target businesses; carry out appropriate financial management; and thereby cause the company to continuously grow in harmony with the society.

In FIG. 1, an MEVA is calculated from a capital cost ratio calculated based on a required capital composition which is obtained from changes in earnings, by applying the concept of risk capital.

The market efficiency value added (MEVA) is calculated as:

market efficiency value added=after-tax operating profit−invested capital cost. (1)

After-tax operating profit is an amount of money obtained as a result of subtracting corporate tax from the sum of ordinary profit and interest expense, while invested capital cost (invested capital expense) is expense incurred in expanding or starting business. That is, the invested capital cost for an operating department of an enterprise is the invested capital cost assigned to the operating department from the entire invested capital cost incurred by the enterprise.

The market efficiency value added (MEVA) is further expressed as:

market efficiency value added=(after-tax operating profit/invested capital−capital cost ratio)×invested capital. (2)

A capital cost ratio is the ratio of the cost for invested capital to the invested capital.

Invested capital cost is expense incurred or to be incurred in expanding or starting business, and made up of the expense (interest expense) for borrowed money (debt) and dividends paid to the shareholders who offered the business fund by purchasing the shares. After-tax operating profit minus invested capital cost equals net business profit.

Invested capital is capital (business fund) invested to set up and carry out business, and expressed as:

invested capital=debt+capital (or owners' equity). (3)

Therefore, invested capital is the sum of the amount of money borrowed from financial institutions such as banks to set up and carry out business and a capital obtained as a result of issuing stocks, etc., for example. Invested capital is expense needed to expand or start a business, and, that is, capital investment incurs cost, which is referred to as invested capital cost. The ratio of the entire invested capital cost to the invested capital is the capital cost ratio. That is, a capital cost ratio is the ratio of the expense (cost) incurred by a target operating department of an enterprise to carry out business, to the capital invested for the department.

There are two types of invested capital cost: cost for the debt (debt cost) included in invested capital and cost for the equity (shareholders' equity cost) also included in the invested capital. Specifically, debt cost (Rd) is expense (interest expense) incurred for borrowed money (debt), while shareholders' equity cost (Re) is dividends paid to the shareholders who offered the business fund by purchasing the shares. Debt cost and shareholders' equity cost correspond to debt and capital, respectively (in the above formula (3)), and their proportions differs from one business operation to another. Therefore, a weighted average of debt cost and shareholders' equity cost is obtained when calculating a capital cost ratio. That is, a capital cost ratio is a cost incurred for each unit invested capital. From the above formulas (1) and (2), invested capital cost is equal to invested capital multiplied by the capital cost ratio.

invested capital cost=capital cost ratio×invested capital (4)

Thus, to calculate invested capital cost from the invested capital, it is necessary to obtain the capital cost ratio. By appropriately selecting (calculating) the capital cost ratio, the invested capital cost can be properly calculated from the invested capital.

Invested capital cost is the sum of the expense incurred (or to be incurred) by an operating department to expand or start business and the expense (interest cost) incurred by the operating department to borrow money (debt) to expand or start the business. Therefore,

invested capital cost=debt cost×debt+shareholders' equity cost×capital (or shareholders' equity). (5)

This means that a capital cost ratio is calculated by obtaining a weighted average of the debt cost and the shareholders' equity cost. Thus, if the capital cost ratio for the capital invested (or to be invested) in a target operating department can be calculated, the invested capital cost incurred for the capital is obtained for the operating department. Then, if the after-tax operating profit is obtained using accounting principles, the market efficiency value added (MEVA) can be calculated by use of the invested capital cost. Conversely, if the invested capital cost for given invested capital is obtained, it can be determined (or estimated) how much after-tax operating profit is needed for the operating department to be financially sound, which is indicated by a market efficiency value added (MEVA). Based on this market efficiency value added (MEVA) and monetary evaluations, it is possible to make fundamental managerial decisions as to investment and withdrawal which directly affect the price and cost when it is necessary to expand or start business.

To calculate the market efficiency value added (MEVA) for each operating department, firstly it is necessary to calculate the debt cost, which is the borrowing rate for the money borrowed from a bank.

In processing to calculate a debt cost, firstly a target rating is set for an operating department of an enterprise whose MEVA is to be calculated, at step 100. After setting the target rating for the operating department at step 100, the bankruptcy probability of the operating department is determined at step 102. A bankruptcy probability is related to a credit risk and referred to as a debt default ratio (or default ratio). After determining the bankruptcy probability of the operating department at step 102, the debt cost Rd (the borrowing rate for the money borrowed from a bank) is determined at step 104.

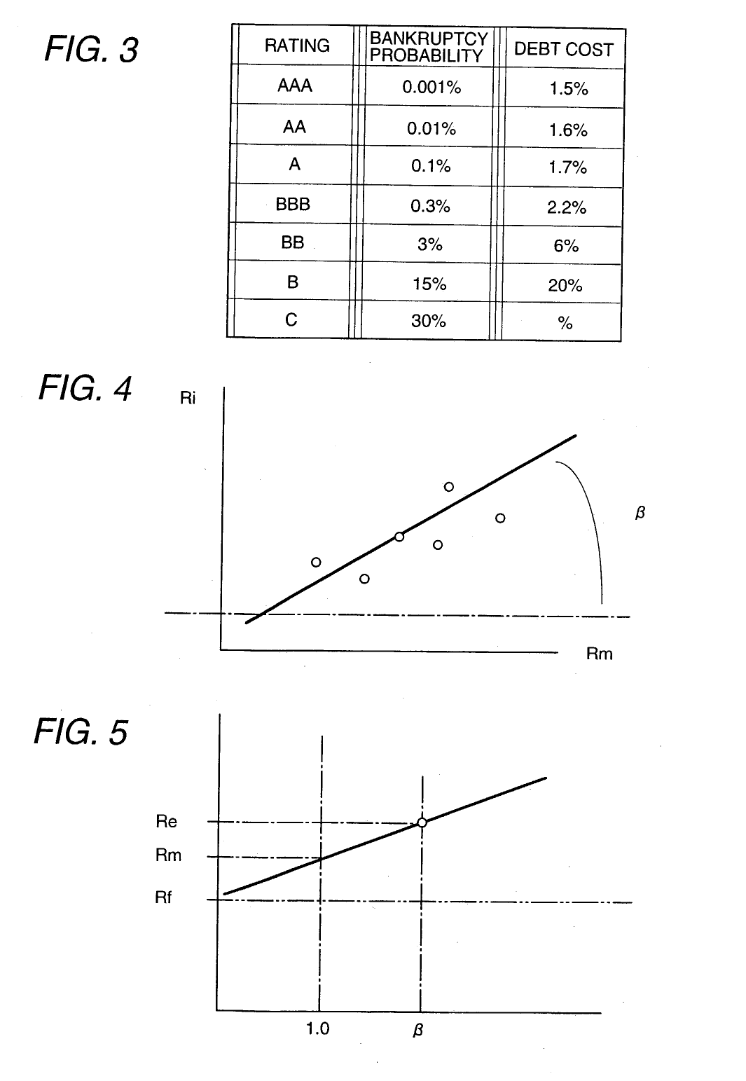

The target rating is set as an evaluation target within the enterprise based on a table as shown in FIG. 3. For example, all operating departments of the enterprise may be set to the single rating “A”, or some operating departments may be set at the rating “A” and the others may be set at the rating “BBB” based on internal evaluation. The rating table shown in FIG. 3 indicates the ratings “AAA”, “AA”, “A”, “BBB”, and so on, and a bankruptcy probability and a debt cost (a bank borrowing rate) are set for each rating. It should be noted that a debt cost is interest (cost) which must be paid to a bank, etc. from which money was borrowed. In the table, the rating “AAA” has a bankruptcy probability of 0.001% and a debt cost (a bank borrowing rate) of 1.5% assigned thereto. The bankruptcy probability is determined based on the rating, and the required equity ratio (the required capital composition indicated in percentages) is determined from the ROI distribution using the determined bankruptcy probability.

Similarly, the rating “A” has a bankruptcy probability of 0.1% and a debt cost (a bank borrowing rate) of 1.7% assigned thereto. As described above, the following steps are taken in the operation to calculate the debt cost: a target rating is set for an enterprise at step 100; a bankruptcy probability is determined at step 102; and the debt cost is determined at step 104. For example, if the target rating is set at the rating “A”, the bankruptcy probability and the debt cost are calculated to be 0.1% and 1.7%, respectively. If the target rating is set at the rating “BBB”, the bankruptcy probability is 0.3% and the debt cost is 2.2%.

Then, subsequent steps carry out the processing to calculate the shareholders' equity cost for the target operating department. Shareholders' equity cost is cost (dividends paid to the shareholders) for shareholders' equity (investment money which the shareholders offered by purchasing the shares). In the processing to calculate the shareholders' equity cost (Re), firstly at step 106, a share price risk β is obtained based on changes in past share prices represented by a graph, as indicated in FIG. 4, showing the relationship between the per share earning ratio (Ri) of the target enterprise (or if the target enterprise is not listed, the per share earning ratio of a company in the same trade is used) and the per share earning ratio (Rm) for the composite stock price index for the market. At step 108, the shareholders' equity cost (Re), which is the expected earning ratio for the shareholders of the enterprise, is obtained from a risk-free interest rate (Rf), such as one for government bonds, and the per share earning ratio (Rm) for the composite stock price index for the market using a capital asset pricing model (CAPM) as shown in FIG. 5 based on the share price risk in FIG. 4. The share price risk β is calculated by the following formula.

β=(covariance between share price and TOPIX)/(variance of TOPIX) (6)

In the operation to calculate the shareholders' equity cost (Re) based on the changes in share price, a graph as shown in FIG. 4 is used in which the horizontal axis indicates the per share earning ratio (Rm) for a market composite stock price index (for example, the Tokyo Stock Price Index abbreviated as TOPIX), and the vertical axis indicates the per share earning ratio (Ri) of the target enterprise (or if the target enterprise is not listed, the per share earning ratio of a company in the same trade is used). Actual values are plotted at intervals such as daily, weekly, or monthly for a few tens of unit periods to obtain the share price risk β (the inclination of the line in FIG. 4). Specifically, the share price risk β (the inclination of the line in FIG. 4) is calculated from the past data of the per share earning ratio (Ri) of the target enterprise (or if the target enterprise is not listed, the per share earning ratio of a company in the same trade is used) and the per share earning ratio (Rm) for a market composite stock price index (for example, the Tokyo Stock Price Index) by use of the following formula.

Ri=α+β×Rm+εi (7)

With the share price risk β determined, it is possible to obtain the per share earning ratio (Ri) of the target enterprise (or if the target enterprise is not listed, the per share earning ratio of a company in the same trade is used) corresponding to the per share earning ratio (Rm) for a market composite stock price index (for example, the Tokyo Stock Price Index) for any period.

After calculating the value of the share price risk β at step 106, the shareholders' equity cost (Re) is calculated. In the operation to calculate the shareholders' equity cost (Re), a graph as shown in FIG. 5 is used in which the horizontal axis indicates the value of the share price risk, and the vertical axis indicates the per share earning ratio (R). In FIG. 5, the per share earning ratio (R) at the share price risk value 1.0 corresponds to the per share earning ratio (Rm) for a market composite stock price index (for example, the Tokyo Stock Price Index), while the per share earning ratio indicated by Rf corresponds to a risk-free interest rate such as one for government bonds (for example, 2%). The per share earning ratio obtained when the share price risk is equal to the share price risk value β obtained in FIG. 4 corresponds to the shareholders' equity cost (Re). Thus, the value of the share price risk β decides the return, that is, the shareholders' equity cost (Re).

Therefore, the shareholders' equity cost (Re) is calculated from the risk-free interest (Rf) such as one for government bonds and the per share earning ratio (Rm) for a market composite stock price index based on a capital asset pricing model (CAPM) as shown in FIG. 5 by use of the following formula.

Re=Rf+β×(Rm−Rf) (8)

Thus, the shareholders' equity cost (Re) can be obtained by finding the intersection point between the share price risk β (line) and the line (risk-return line) drawn through the point for the risk-free interest (Rf) and the point for the per share earning ratio (Rm) for the market composite stock price index (TOPIX) (whose share price risk value is 1.0). That is, the value of the return (R) (for example, 8%) obtained when the share price risk is at the value β corresponds to the shareholders' equity cost (Re).

After determining the bankruptcy probability (for example, 0.1%) at step 102, the required capital composition (the ratio between the debt and the equity) is calculated at step 112 based on the ROI probability distribution obtained at step 110. In the estimation of the required capital composition (the ratio between the debt and the equity), a graph (an ROI distribution curve) as shown in FIG. 2 is used in which the horizontal axis indicates the ROI (Return On Investment) distribution (%) and the vertical axis indicates the probability frequency, stochastically indicating the ratio of the return to the invested money. A bankruptcy probability (for example, 0.1%) is set based on the business risk (the return distribution) indicated by the graph to obtain the equity ratio. Thus, the bankruptcy probability and the equity ratio change with the business risk (the return distribution).

The ROI distribution curve shown in FIG. 2 has its peak at a certain point (in this case, 8%). Specifically, in the ROI distribution curve of FIG. 2, the left-hand side of the point (8%) indicates red figures, while the right-hand side indicates black figures. The point “0” indicates an equity ratio of 0%.

In the ROI distribution curve of FIG. 2, let the entire area defined by the curve be 1, and find a point (a value of the ROI) on the red-figure side (the left-hand side) which defines an area of 0.001 (0.1% of the entire area) from the left end as indicated by the shaded area in the figure. The area of 0.001 (0.1% of the entire area) indicates the probability of incurring a deficit larger than that indicated by this point (the ROI value), that is, the bankruptcy probability (0.1%) for the point. The ROI value is −40% in the figure, indicating an equity ratio of 40%. This means that the enterprise (or the operating department) represented by the ROI distribution curve shown in FIG. 2 has invested capital (debt+equity) in which the proportion of the equity is 40%. Therefore, the enterprise (or the operating department) must have an equity ratio of 40% to have a bankruptcy probability of 0.1% (that is, to be rated as the rating “A”). If the enterprise (or the operating department) has an equity ratio of 35%, it has a higher bankruptcy probability, resulting in a lower rating. If the enterprise (or the operating department) has an equity ratio of 40% (that is, the equity proportion is 40%), a deficit lower than that indicated by the ROI value of −40% can be compensated by reducing the equity (without affecting the debt). In short, the probability of the target operating department turning to red figures, which might lead to bankruptcy, is 0.1%.

However, if the equity ratio is reduced to 30% (indicated by the point of −30% in the ROI distribution curve), the area of the left end portion becomes larger. Thus, if the enterprise represented by the ROI distribution curve shown in FIG. 2 has an equity ratio of smaller than 40%, its bankruptcy probability becomes larger than 0.1%. With a larger bankruptcy probability, the enterprise might go bankrupt if it has a large deficit since reducing the equity is not enough to prevent the bankruptcy. Thus, if an operating department having the ROI distribution shown in FIG. 2 has an equity ratio of 40%, its bankruptcy probability is 0.1%. The bankruptcy probability 0.1% corresponds to the rating “A”, which is assigned a debt cost of 1.7%. A debt cost is interest for raising fund. With the rating “A”, it is possible to borrow money from a financial institution at an interest rate of 1.7%. Accordingly, a higher rating (that is, a smaller bankruptcy probability) of an operating department requires a higher equity ratio. Thus, reducing the equity ratio increases the bankruptcy probability, resulting in a lower rating and increased debt cost.

Since the operating department having the ROI distribution curve shown in FIG. 2 sets its shareholders' equity cost at the peak point 8%, step 114 calculates the weighted average of the debt cost (1.7%) and the shareholders' equity cost (8%) to obtain the capital cost ratio.

The required capital composition (debt:equity=60:40) and the capital cost ratio are thus calculated. After the calculation of the capital cost ratio, the after-tax operating profit is calculated using accounting principles at step 120. Then, step 122 calculates the ratio (profit ratio) of the after-tax operating profit obtained using accounting principles at step 120, to the invested capital (debt+equity). Step 114 subtracts the calculated capital cost ratio from the profit ratio (the ratio of the after-tax operating profit to the invested capital) to obtain the market efficiency value added (MEVA).

The calculation of the enterprise risk (return distribution) performed at step 110 will be described below. Step 110 obtains an ROI (Return On Investment) probability distribution function for the enterprise in the calculation of the enterprise risk (return distribution) by use of, for example, an RVM method in which selection is made using matrices.

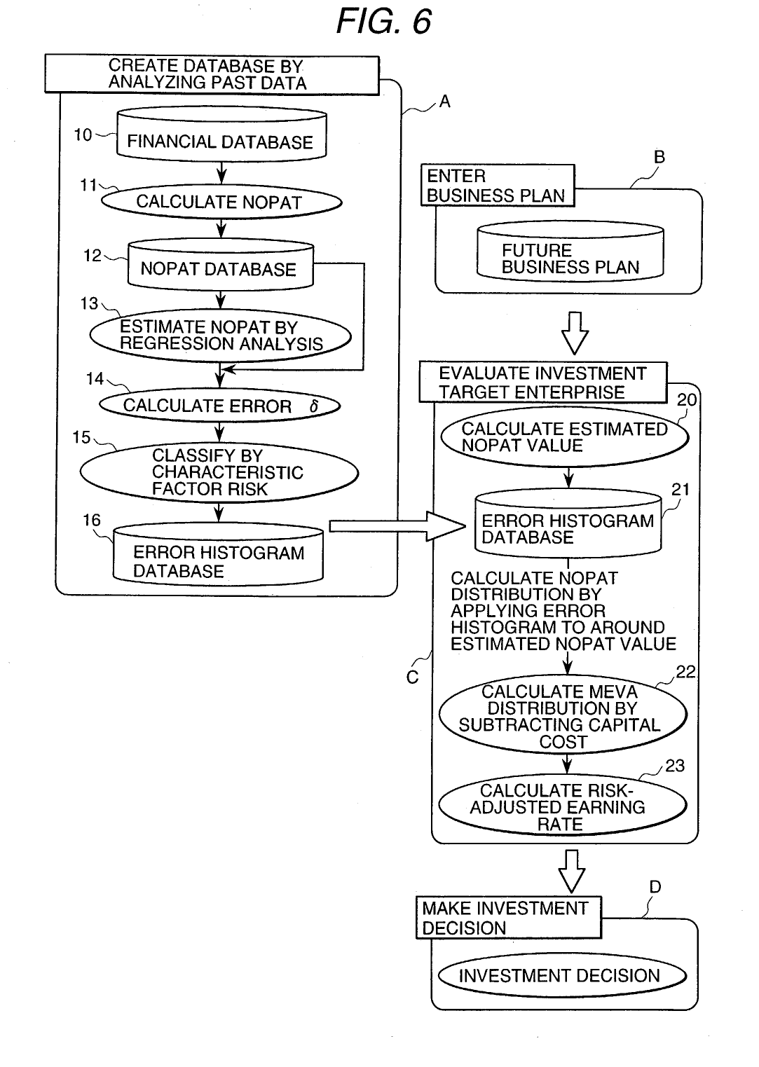

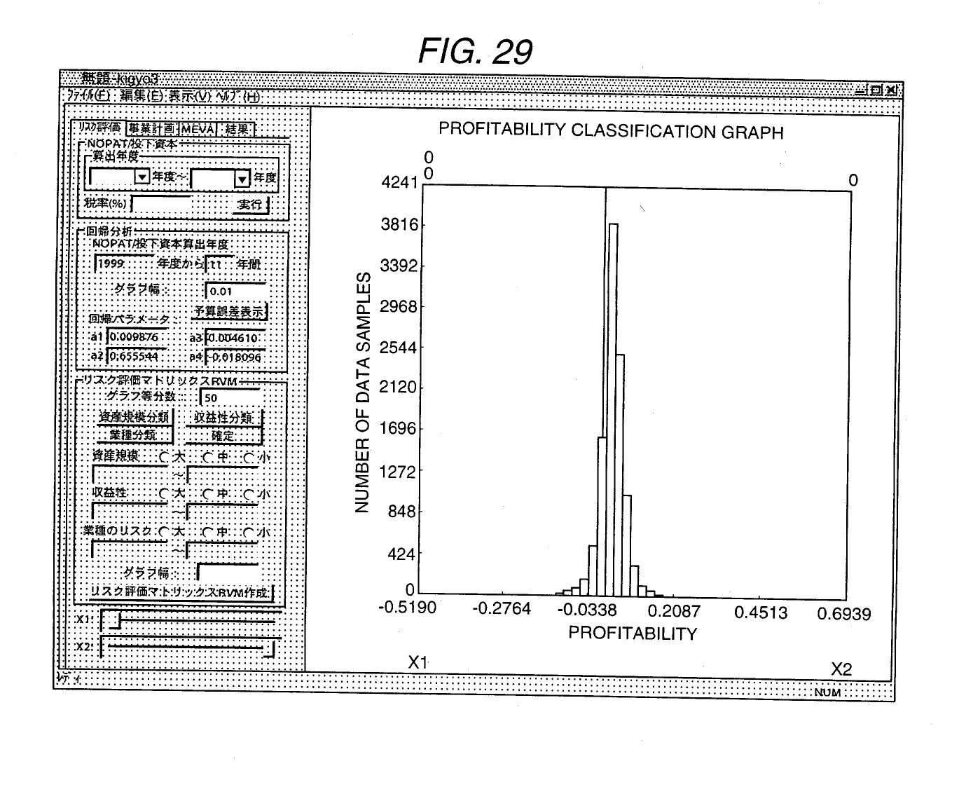

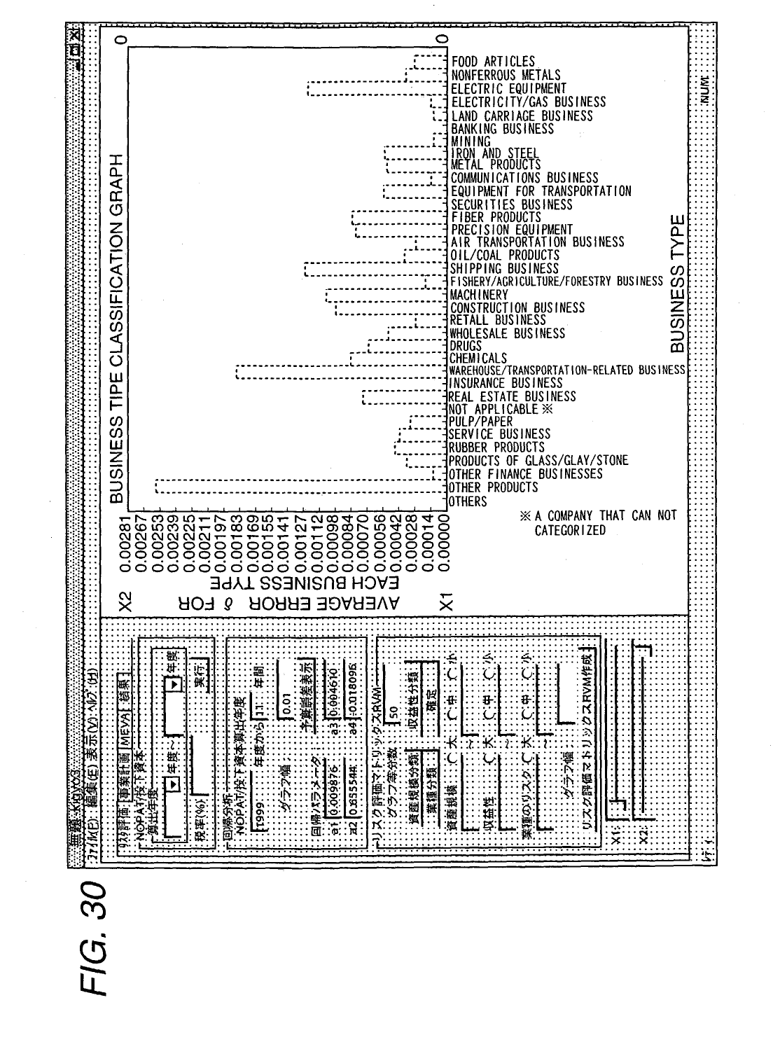

Detailed description will be made below of an operation to calculate a debt-to-equity ratio using an RVM method in which an ROI probability distribution function of an enterprise is selected from matrices, with reference to FIGS. 6 to 30.

FIG. 6 is a processing flowchart for preparing a management index employed by a management index processing system to determine whether to invest in a new business according to an embodiment of the present invention.

In the figure, reference numeral A denotes a processing flowchart for analyzing past data and creating a database; B denotes a processing flowchart for entering a business plan; C denotes a processing flowchart for evaluating the value of an enterprise which is a target of investment; and D denotes a processing flowchart for making an investment decision. These processing flowcharts are executed by a processing unit (not shown).

The processing flowchart A for analyzing past data to create a database includes the following steps. Step 10 creates a financial database storing past financial data. Based on the created financial database, an NOPAT (Net Operating Profit After Tax) is calculated at step 11. After the calculation of the NOPAT at step 11, an NOPAT database is created at step 12. Step 13 estimates an NOPAT based on the NOPAT database by use of a regression analysis method. Then, step 14 calculates an estimation error δ from the NOPAT estimated at step 13. The estimation error δ calculated at step 14 is classified by the risk of a characteristic factor at step 15. After the estimation error δ was classified by the risk of the characteristic factor at step 15, step 16 creates an error histogram and stores it in an error histogram database.

The processing flowchart C for evaluating the value of an enterprise which is a target of investment includes the following steps. Step 20 calculates an estimated NOPAT value. Based on the error histogram data created and stored at step 16, step 21 obtains an NOPAT distribution by applying the error histogram to around the estimated NOPAT value. Step 22 subtracts the capital cost from the NOPAT distribution to obtain an MEVA distribution, and then step 23 calculates the risk-adjusted earning rate.

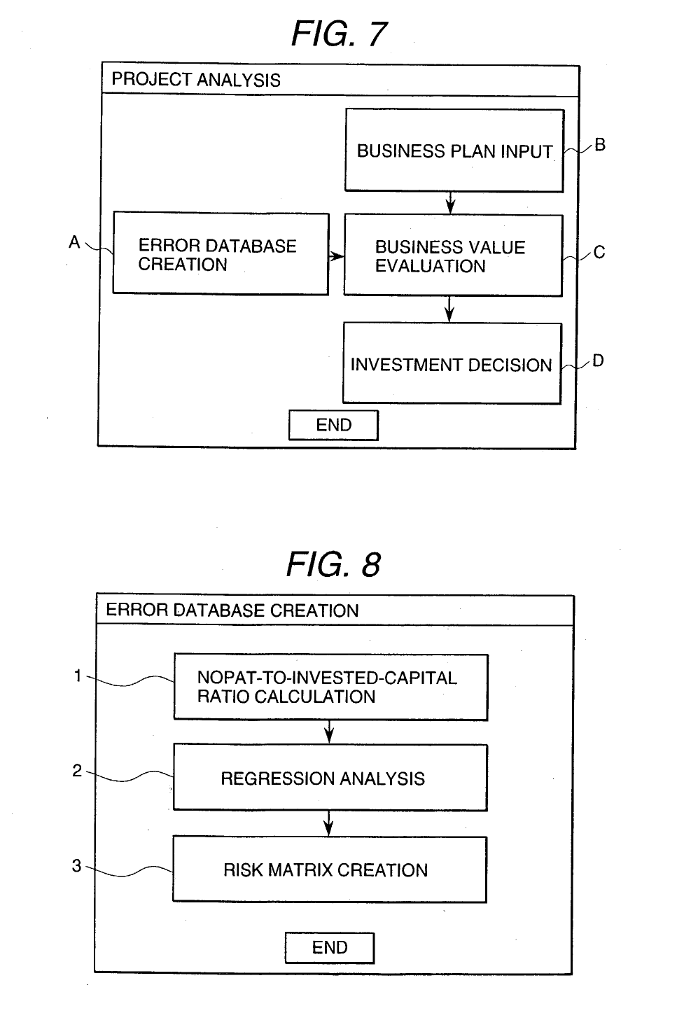

Starting up the processing unit displays a project analysis message screen as shown in FIG. 7 on the display. The project analysis message screen shown in FIG. 7 includes an error database creation processing section A, a business plan input section B, a business value evaluation section C, and an investment decision section D. The error database creation processing section A corresponds to the processing flowchart A shown in FIG. 6. Likewise, the business plan input section B, the business value evaluation section C, and the investment decision section D correspond to the processing flowcharts B, C, and D shown in FIG. 6, respectively.

On the project analysis message screen shown in FIG. 7, selecting (clicking) the error database creation processing section A executes the processing flowchart A in FIG. 6 for analyzing past data and creating a database. Specifically, on the project analysis message screen shown in FIG. 7, selecting (clicking) the error database creation processing section A displays an error database creation message screen as shown in FIG. 8. The error database creation message screen shown in FIG. 8 is provided to set a specific processing flow for the error database creation processing section A on the project analysis message screen shown in FIG. 7. The message screen shown in FIG. 8 is used to execute NOPAT-to-invested-capital ratio calculation processing 1, regression analysis processing 2, and risk matrix creation processing 3. The NOPAT is expressed by the following formula.

NOPAT=(operating profit+nonoperating income−nonoperating expense+interest expense×total discount charge)×(1−tax rate) (9)

The invested capital is calculated by the equation:

invested capital=short-term loan payable+long-term loan payable+equity.

The NOPAT and the invested capital may be modified using other financial data.

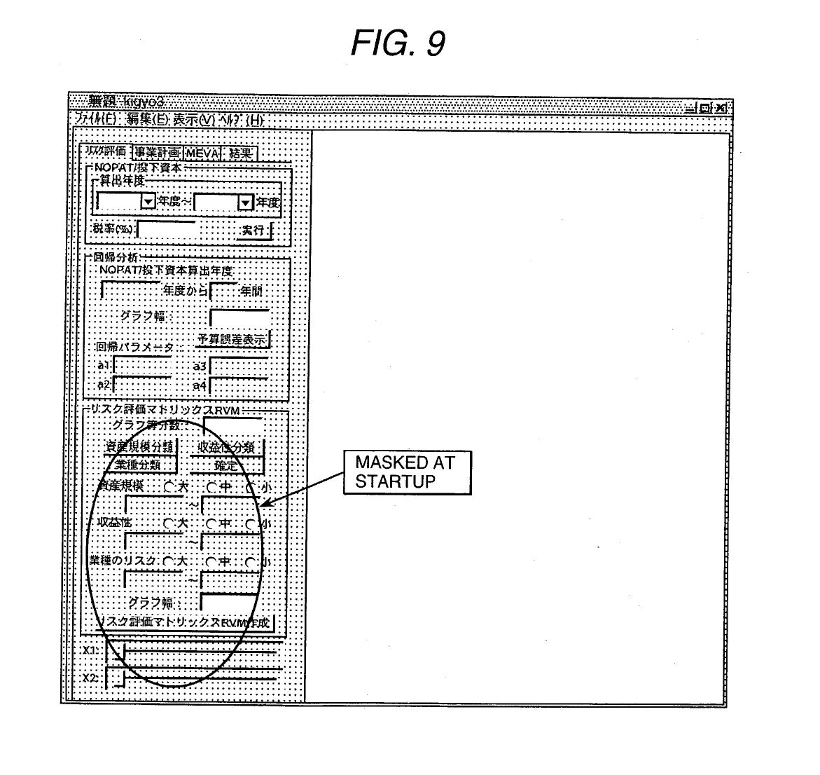

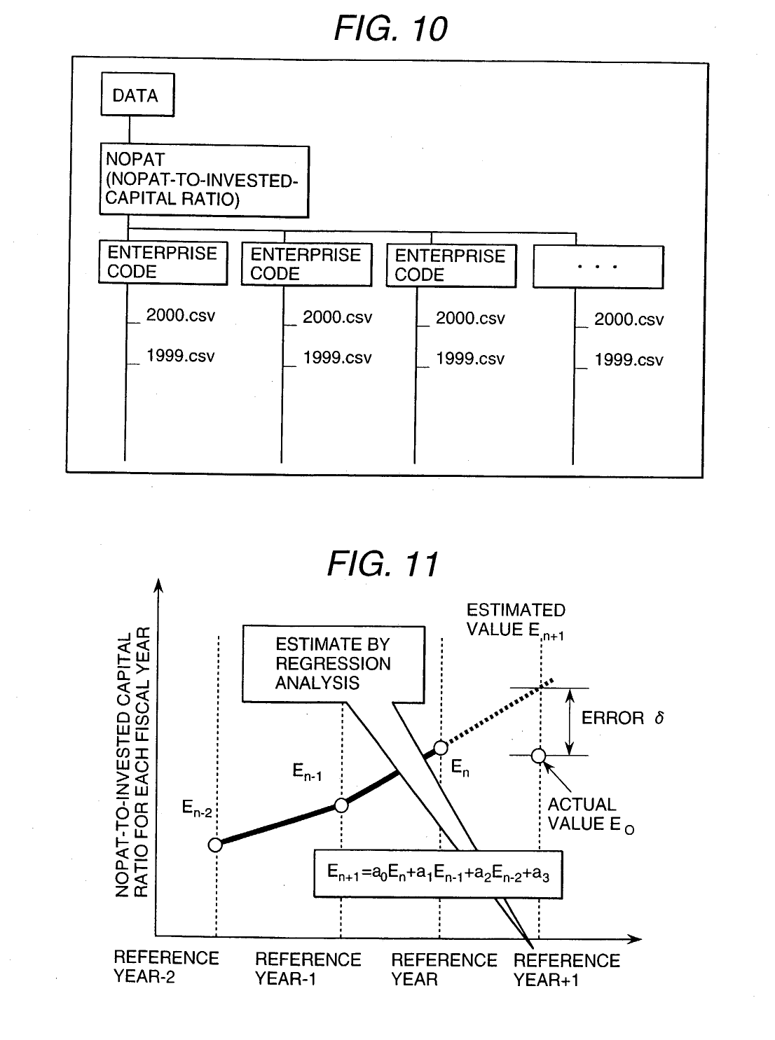

On the project analysis message screen shown in FIG. 7, selecting (clicking) the error database creation processing section A displays the error database creation message screen shown in FIG. 8. Then, on the error database creation message screen shown in FIG. 8, selecting (clicking the indication of) the NOPAT-to-invested-capital ratio calculation processing 1 displays a risk evaluation display screen as shown in FIG. 9. On the risk evaluation display screen shown in FIG. 9, enter the fiscal years 1990 to 2000 as targets of calculation and a value of 41.8% as the tax rate (corporate tax) for these years, for example, and press the enter key. In response, the system reads the past financial data of each enterprise stored in a database as shown in FIG. 10 and calculates the NOPAT-to-invested-capital ratio for each fiscal year for a period (data collection period) specified for each enterprise. The database shown in FIG. 10 stores data classified by enterprise code and fiscal year. The calculated NOPAT-to-invested-capital ratio for each fiscal year is stored in the database.

After the past NOPAT-to-invested-capital ratio for each fiscal year for each enterprise was calculated (by selecting the NOPAT-to-invested-capital ratio calculation processing 1 on the error database creation message screen shown in FIG. 8), the regression analysis processing 2 on the error database creation message screen shown in FIG. 8 is selected (clicked) to execute the processing.

The regression analysis processing 2 indicated on the error database creation message screen shown in FIG. 8 creates an NOPAT-to-invested-capital estimation model, as indicated in FIG. 11. The regression analysis uses a graph in which the horizontal axis indicates the fiscal year and the vertical axis indicates the NOPAT-to-invested-capital ratio as indicated in FIG. 11. This regression analysis uses the data for the most recent year (reference year) and the previous two years to predict the NOPAT-to-invested-capital ratio for the year next to the reference year. In FIG. 11, which shows data of NOPAT-to-invested-capital ratios, reference numeral En denotes the NOPAT-to-invested-capital ratio for the reference year; En−1 denotes the NOPAT-to-invested-capital ratio for the year immediately before the reference year (reference year −1); and En−2 denotes the NOPAT-to-invested-capital ratio for the year two years before the reference year (reference year −2). These three NOPAT-to-invested-capital ratios En, En−1, and En−2 are used to estimate the NOPAT-to-invested-capital ratio En+1 for the year next to the reference year (the reference year +1). In this estimation, regression analysis parameters a0, a1, a2, and a3 are obtained based on the NOPAT-to-invested-capital ratios for the past three years through the regression analysis, and the NOPAT-to-invested-capital ratio for the target year is estimated based on the obtained parameters by use of the formula indicated in FIG. 11. The estimation error δ is the difference between the NOPAT-to-invested-capital ratio En+1 estimated in FIG. 11 and the actual value E0. The regression parameters a0, a1, a2, and a3 are each indicated in a respective field.

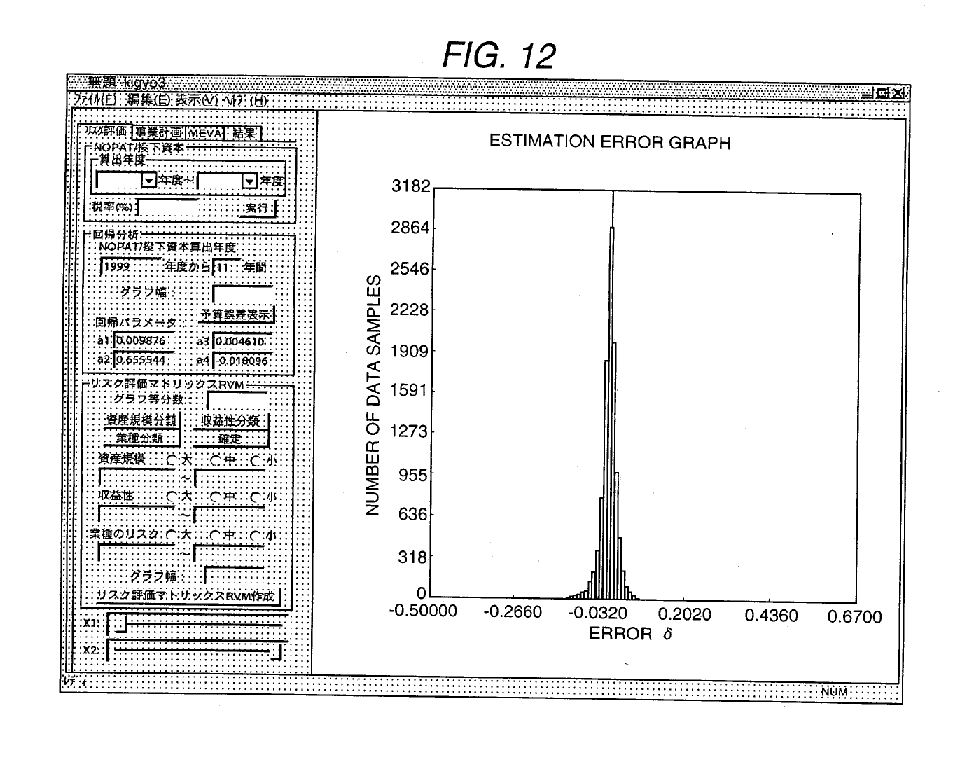

The regression parameters a0, a1, a2, and a3 are thus used to obtain the estimation error δ in the estimated NOPAT-to-invested-capital ratio for each fiscal year for each enterprise for a specified period (data collection period). FIG. 12 includes a histogram showing a frequency distribution of the estimation errors δ in all the estimated NOPAT-to-invested-capital ratios. The preparation of the estimation error δ histogram shown in FIG. 12 completes the regression analysis processing 2 on the error database creation message screen shown in FIG. 8.

In the regression analysis processing 2, a target fiscal year, whose NOPAT-to-invested-capital ratio is to be estimated, and the number of subsequent target fiscal years are read from a file and displayed on a display screen as shown in FIG. 12. A desired graph width (for example, 0.01) for the bar graph to be displayed is entered and press the Display Estimation Errors button is pressed. Then, the system produces data of a number of estimation errors δ equal to the expression: the number of the enterprises×(NOPAT/the number of the target fiscal years −3). In the above expression, a number of 3 is subtracted from the number of the target fiscal years because data for the past three years are used for the regression analysis. Regression parameters a1, a2, a3, and a4 determined here are displayed in the regression parameter boxes on the display screen. In addition to the regression parameters a1, a2, a3, and a4, the display screen shown in FIG. 12 displays a frequency distribution graph which indicates data of a number of estimation errors δ equal to the expression: the number of the enterprises × (the number of the target fiscal years −3). That is, the total number of data samples (NOPAT/the number of data samples are indicated on the vertical axis) in the “estimation error δ data frequency distribution” graph displayed on the display screen in FIG. 12 is equal to the expression: the number of the enterprises × (NOPAT/the number of the target fiscal years −3). Thus, FIG. 12 is a histogram indicating a frequency distribution of the estimation errors δ.

After the regression analysis processing 2 indicated on the error database creation message screen shown in FIG. 8 is completed, the risk matrix creation processing 3 on the error database creation message screen in FIG. 8 is selected (clicked) to create a risk matrix.

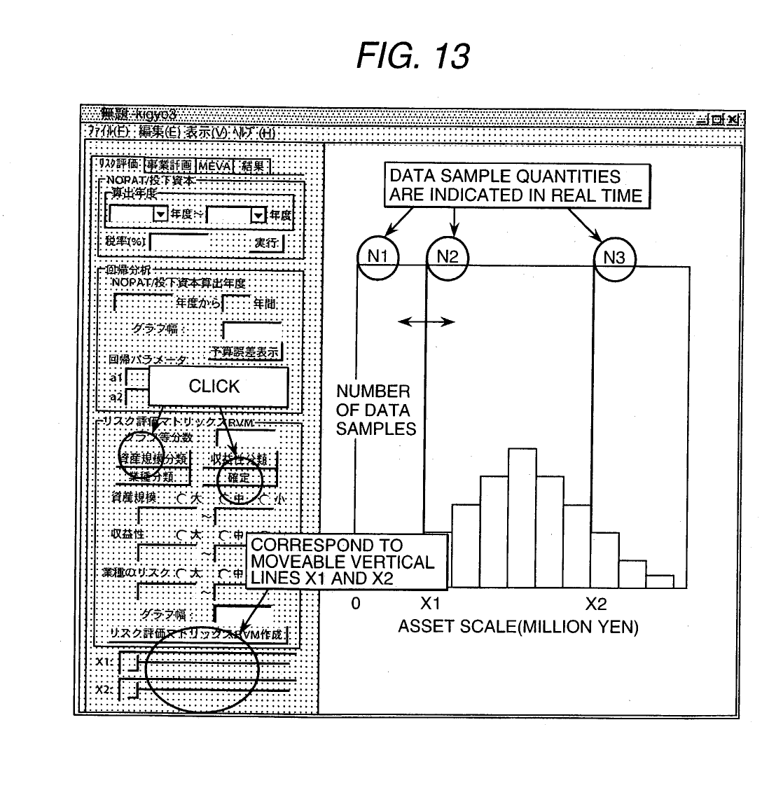

The histogram of estimation errors δ in FIG. 12 was obtained as a result of simply counting estimation errors δ for all enterprises in all types of business, and has not yet been subjected to any statistical processing. Therefore, it is necessary to classify the data by characteristic factor and the degree of risk such as the high risk type, the middle risk type, and the low risk type so as to form matrices (risk matrices). Specifically, on the display screen in FIG. 13, the data is classified by three characteristic factors: asset scale, profitability, and business type. Then, the classified data is further divided by the degree of risk such as the high risk type, the middle risk type, and the low risk type. Thus, since each of the three characteristic factors is classified into the three risk types such the high risk type, the middle risk type, and the low risk type, the histogram of the estimation errors δ can include 27 types of matrix data. It should be noted that the present embodiment classifies the data into three risk types such as the high risk type, the middle risk type, and the low risk type. However, the data may be divided into five risk types such as the extremely high risk type, the high risk type, the middle risk type, the low risk type, and the extremely low risk type. Furthermore, the present embodiment classifies the data by the three characteristic factors. However, the data may be classified by two or four or any number of characteristic factors. To equally divide the graph (data) into three portions, a number of 3 is entered into the “number of equally divided graph portions” field on the display screen in FIG. 13. To equally divide the graph (data) into four portions, a number of 4 is entered into the field.

FIGS. 28, 29, and 30 show graphs obtained as a result of classifying data by asset scale, profitability, and business type, respectively. For each characteristic factor to be able to be used as an objective evaluation factor, it is appropriate that there be approximately 1000 estimated values for each factor in a matrix. For example, assume that there are 3500 enterprises, and data of the estimation error δ for these enterprises is obtained for the past five years. In such a case, a total of 17500 samples of the estimation error δ are obtained (for the 3500 enterprises), providing 648 samples of the estimation error δ for each factor in a matrix.

Now, matrices are created using characteristic factors from the histogram of the estimation errors δ in FIG. 12. The asset scale, the profitability, and the business type are used as the characteristic factors, and data is counted for each characteristic factor, as shown in FIG. 13. Clicking “Asset Scale Classification” on the display screen in FIG. 13 displays a frequency distribution graph prepared using data of all enterprises. The horizontal axis indicates the asset scale (million yen). In the asset scale classification, the enterprises are classified by asset scale. The profitability classification uses the average of the NOPAT-to-invested-capital ratios for each enterprise for the past several fiscal years. The business type classification uses the type of business in which each enterprise is engaged.

Fist of all, matrices will be prepared based on the asset scale classification. In the preparation of matrices using asset scales, all the enterprises included in the histogram of the estimation errors δ in FIG. 12 are arranged in the order of increasing asset scale on the horizontal axis, and the number of the samples of the estimation error δ for each range of asset scale is taken on the vertical axis. On the horizontal axis, the unit of the asset scale may be a capital of 100 million yen. Thus, the data samples (estimation errors) are counted for each range of asset scale to obtain the number of data samples to be indicated on the vertical axis.

Thus, in the preparation of matrices using asset scales, all enterprises are arranged in the order of increasing asset scale on the horizontal axis, and the number of the samples of the estimation error δ for each range of asset scale is taken on the vertical axis, as shown in FIG. 13. As shown in FIG. 13, the estimation errors in the NOPAT-to-invested-capital ratios are classified by a characteristic factor (asset scale) to produce histograms to be used as each factor in a risk matrix. The histograms are divided into three groups, for example, the large (asset scale) group, the middle (asset scale) group, and the small (asset scale) group. For each characteristic factor to be able to be used as an objective evaluation factor, each block includes an equal number of data samples. The asset scale points X1 and X2 in FIG. 13 are set such that the data sample quantities N1, N2, and N3 in FIG. 13 are equal to one another (actually, since it is not possible to set N1, N2, and N3 at an exactly equal quantity, N1, N2, and N3 are approximately equal to one another) in order to divide the estimation errors δ into three groups. The sliders at the bottom of the display screen in FIG. 13 can be moved to move the X1 and X2 vertical lines little by little. The X1 and X2 vertical lines can be moved by directly clicking these lines with the cursor (the arrow key on the keyboard). Thus, the X1 and X2 vertical lines can be moved horizontally in the figure by use of the sliders or the cursor so that the data sample quantities N1, N2, and N3 are changed correspondingly, making it easy to set N1, N2, and N3. After setting the positions of the X1 and X2 vertical lines, pressing the Enter button on the display screen in FIG. 13 accepts these positions.

After the risk matrices using asset scales are obtained, risk matrices using profitability are prepared in FIG. 13. In the preparation of risk matrices using profitability, all the enterprises included in the histogram of the estimation errors δ in FIG. 12 are arranged in the order of increasing profitability on the horizontal axis, and the number of the samples of the estimation error δ for each range of profitability is taken on the vertical axis. Thus, the data samples are counted for each range of profitability to obtain the number of data samples to be indicated on the vertical axis.

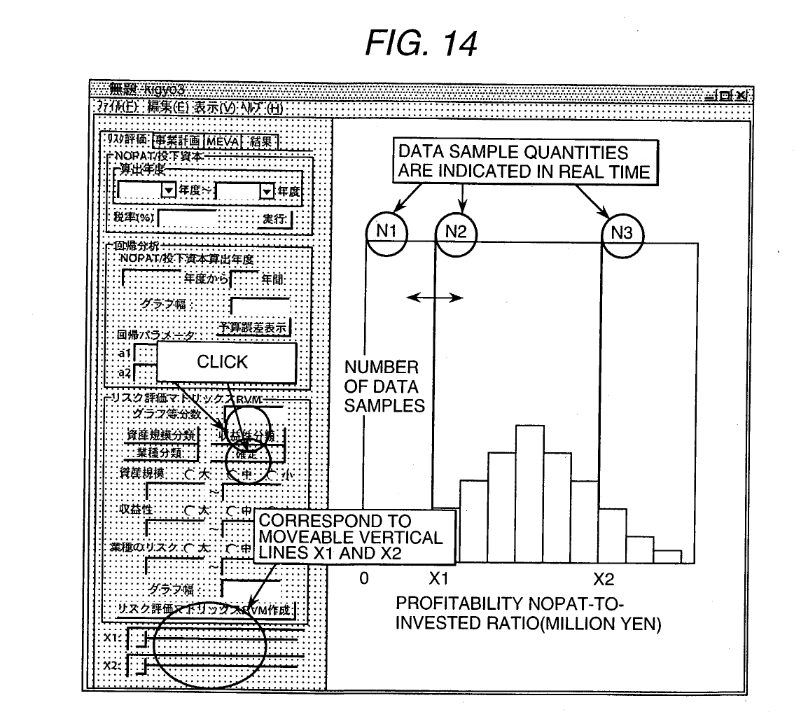

Thus, in the preparation of matrices using profitability, all the enterprises are arranged in the order of increasing profitability on the horizontal axis, and the number of the samples of the estimation error δ for each range of profitability is taken on the vertical axis, as shown in FIG. 14. As shown in FIG. 14, the estimation errors in the NOPAT-to-invested-capital ratios are classified by a characteristic factor (profitability) to produce histograms. The histograms are divided into three groups, for example, the high (profitability) group, the middle (profitability) group, and the low (profitability) group. For each characteristic factor to be able to be used as an objective evaluation factor, each block includes an equal number of data samples. The profitability points X1 and X2 in FIG. 14 are set such that the data sample quantities N1, N2, and N3 in the figure are equal to one another in order to divide the estimation errors δ into three groups. To equally divide the estimation errors into three groups, a number of 3 is entered into the “number of equally divided graph portions” field on the display screen in FIG. 14. To equally divide the estimation errors into four groups, a number of 4 is entered into the field.

The sliders at the bottom of the display screen in FIG. 14 can be moved to move the X1 and X2 vertical lines little by little. It may be arranged such that the X1 and X2 vertical lines can be moved by directly clicking these lines with the cursor. Thus, the X1 and X2 vertical lines can be moved horizontally in the figure by use of the sliders or the cursor so that the data sample quantities N1, N2, and N3 are changed correspondingly, making it easy to set N1, N2, and N3. After setting the positions of the X1 and X2 vertical lines, pressing the Enter button on the display screen in FIG. 14 accepts these positions.

After the risk matrices using profitability are obtained, risk matrices using business types are prepared. In the preparation of risk matrices using business types, all the enterprises included in the histogram of the estimation errors δ in FIG. 12 are classified by business type, and each business type is taken on the horizontal axis. The average error for each business type is taken on the vertical axis.

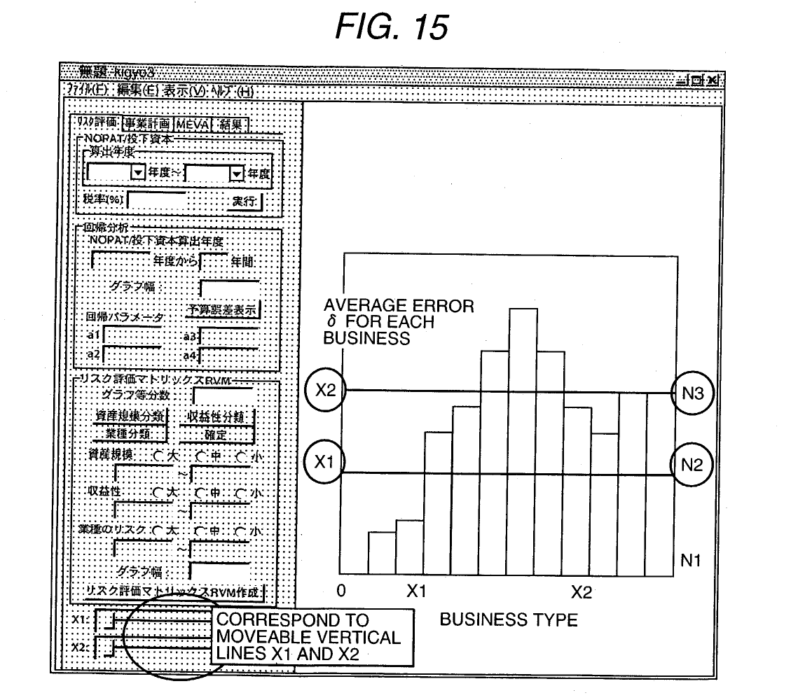

Thus, in the preparation of matrices using business types, the business types of all the enterprises are arranged on the horizontal axis, and an average of the estimation errors δ for each business type is taken on the vertical axis, as shown in FIG. 15. As shown in FIG. 15, the estimation errors δ in the NOPAT-to-invested-capital ratios are classified by a characteristic factor (business type risk) to produce histograms. The histograms are divided into three groups, for example, the high (business type risk) group,. the middle (business type risk) group, and the low (business type risk) group. For each characteristic factor to be able to be used as an objective evaluation factor, each block includes an equal number of samples of the estimation error δ. The points X1 and X2 in FIG. 15 are set such that the sample quantities N1, N2, and N3 of the estimation error δ in the figure are equal to one another, dividing the samples of the estimation error δ into three groups. To equally divide the estimation error samples into three groups, a number of 3 is entered into the “number of equally divided graph portions” field on the display screen in FIG. 15. To equally divide the estimation error samples into four groups, a number of 4 is entered into the field.

The sliders at the bottom of the display screen in FIG. 15 can be moved to move the X1 and X2 vertical lines little by little. It may be arranged such that the X1 and X2 vertical lines can be moved by directly clicking these lines with the cursor. Thus, the X1 and X2 vertical lines can be moved horizontally in the figure by use of the sliders or the cursor so that the data sample quantities N1, N2, and N3 are changed correspondingly, making it easy to set N1, N2, and N3. After setting the positions of the X1 and X2 vertical lines, pressing the Enter button on the display screen in FIG. 15 accepts these positions.

The above classification result by each characteristic factor is stored in a respective data memory area.

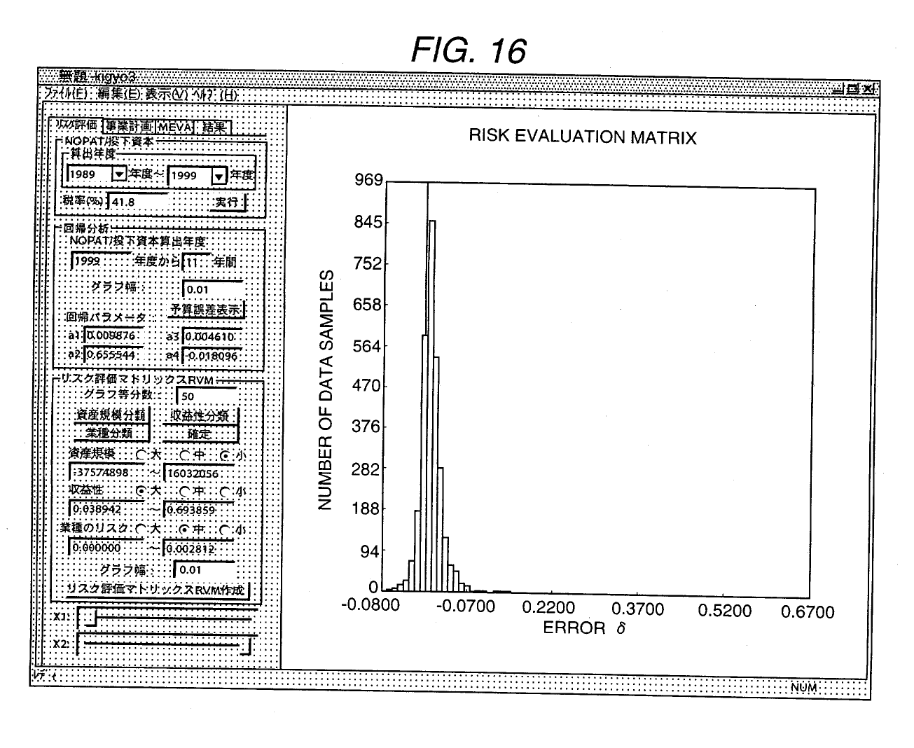

Thus, the samples of the estimation error δ are classified by three factors. The samples classified by each factor are equally divided into three groups. One of the matrices thus classified can be displayed in the “risk evaluation matrix” field on the display screen in FIG. 16. Select one of the asset scale classification, the profitability classification, and the business type classification, and further select one of “High”, “Middle”, and “Low”. Repeat the above process for all the classifications. For example, select (click) “Low” for the asset scale classification, “High” for the profitability classification, and “Middle” for the business type classification, and press the Risk Evaluation Matrix RVM Creation button. Then, a frequency distribution of the samples of the estimation error δ are generated for all possible combinations of the asset scale classification and “High”, “Middle”, and “Low”, and the profitability classification and “High”, “Middle”, and “Low”, and the business type classification and “High”, “Middle, and “Low” (that is, 27 combinations in this example). The generated 27 frequency distributions are stored in a data memory area or in a file as matrices. A frequency distribution graph of the samples of the estimation error δ for all the enterprises meeting the above selected conditions (“Low” for the asset scale classification, “High” for the profitability classification, and the “Middle” for the business type classification) is displayed as shown in FIG. 16.

This completes the error database creation flow in FIG. 8. That is, unless processing up to the step shown in FIG. 15 has been completed and display processing of the samples of the estimation error δ has been carried out based on a selected condition as shown in FIG. 16, the error database creation message screen as shown in FIG. 8 continues to be displayed. Selecting (clicking) “Back” on the error database creation message screen in FIG. 8 displays the project analysis message screen shown in FIG. 7.

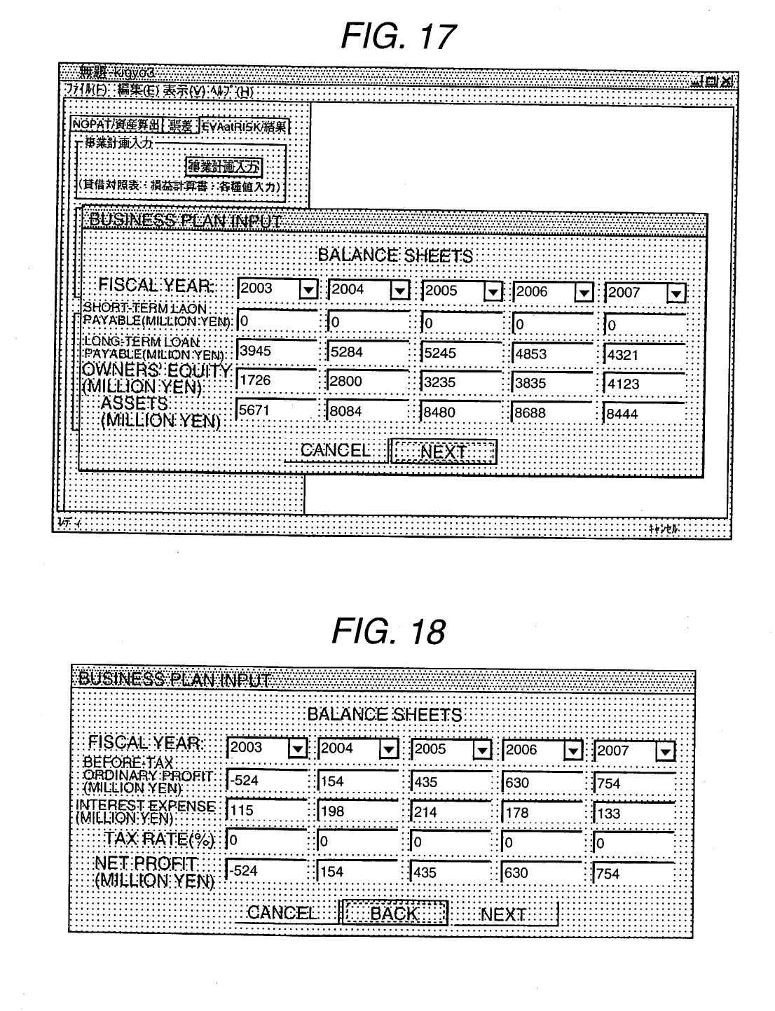

Then, a desired future business plan is entered. Specifically, the business plan input section B is selected (clicked) on the project analysis message screen shown in FIG. 7. Selecting (clicking) the business plan input section B on the project analysis message screen in FIG. 7 executes the processing flowchart B of FIG. 6 for entering a future business plan. That is, selecting (clicking) the business plan input section B on the project analysis message screen shown in FIG. 7 displays a business plan input message screen made up of balance sheets as shown in FIG. 17. The business plan input message screen made up of balance sheets in FIG. 17 is the message screen for setting a specific processing flow for the business plan input section B on the project analysis message screen shown in FIG. 7. A business plan (as to balance sheets) of a business to be evaluated is input on the business plan input message screen made up of balance sheets shown in FIG. 17. The balance sheets included in the business plan for five years (for example) starting from the year in which a new business is to be begun, is filled. It is desirable to fill in five or more years of balance sheets for data accuracy.

The business plan input message screen made up of balance sheets shown in FIG. 17 includes the fields “fiscal year”, “short-term loan payable”, “long-term loan payable”, “owner's equity”, and “assets”. After the balance sheets shown in FIG. 17 have been filled in, a business plan input message screen made up of income statements is displayed, as shown in FIG. 18. A business plan (as to income statements) of the business to be evaluated is input on the business plan input message screen made up of income statements. The business plan input message screen made up of income statements shown in FIG. 18 includes the fields “fiscal year”, “operating profit (before tax)”, “interest expense (interest for loan payable)”, “tax rate”, and “net profit”.

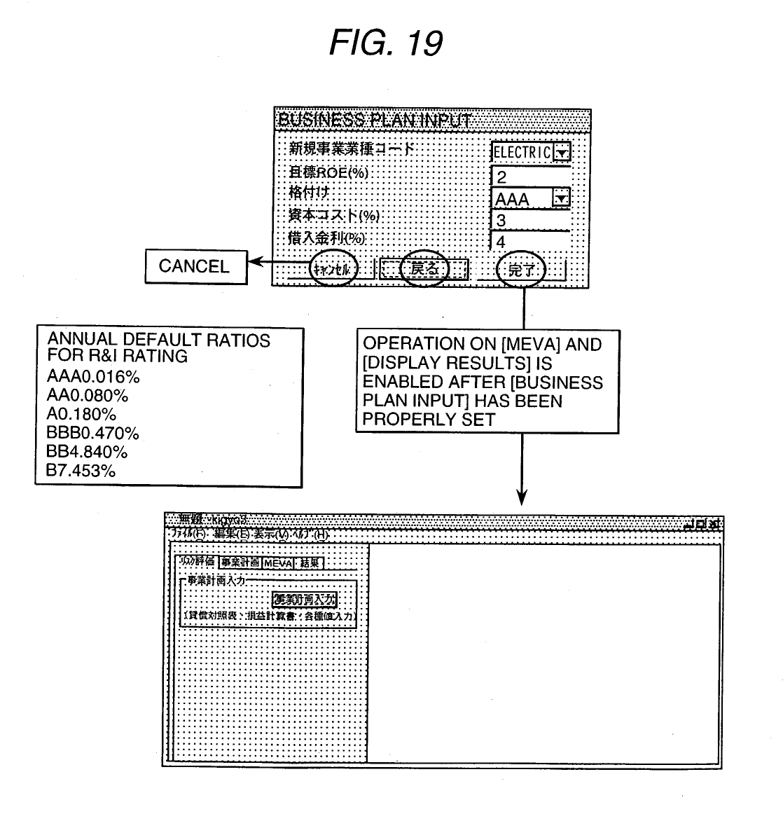

After the income statements of the business plan input message screen shown in FIG. 18 have been filled in, a business plan input message screen as shown in FIG. 19 is displayed. On the business plan input message screen shown in FIG. 19, are set the following items included in the business plan of the business to be evaluated: the new business type code, for example, “electric”; the target ROE (the ratio of net profit to shareholders' equity, which is used as a target value for an investment-target enterprise and indicated in percentages), for example, “2%”; the rating (the rating of an investment-target enterprise, such as “AA”, “A”, “BBB”, etc.), for example, “AAA”; the capital cost (for an investment-target enterprise and indicated in percentages), for example, “3%”; and the borrowing rate (for an investment-target enterprise and indicated in percentages), for example, “4%”.

After the data input on the business plan input message screen shown in FIG. 19 was completed, selecting (clicking) “Back” on the business plan input message screen in FIG. 19 completes the business plan input processing and displays the project analysis message screen shown in FIG. 7. On the other hand, selecting (clicking) “Enter” on the business plan input message screen shown in FIG. 19 enables operation on “MEVA” and “Display Results” after proper completion of the business plan input processing.

Then, business value evaluation processing on the desired future business plan is carried out. Specifically, the business value evaluation section C is selected (clicked) on the project analysis message screen. Selecting (clicking) the business value evaluation section C executes the processing flowchart C of FIG. 6 for evaluating an investment-target enterprise.

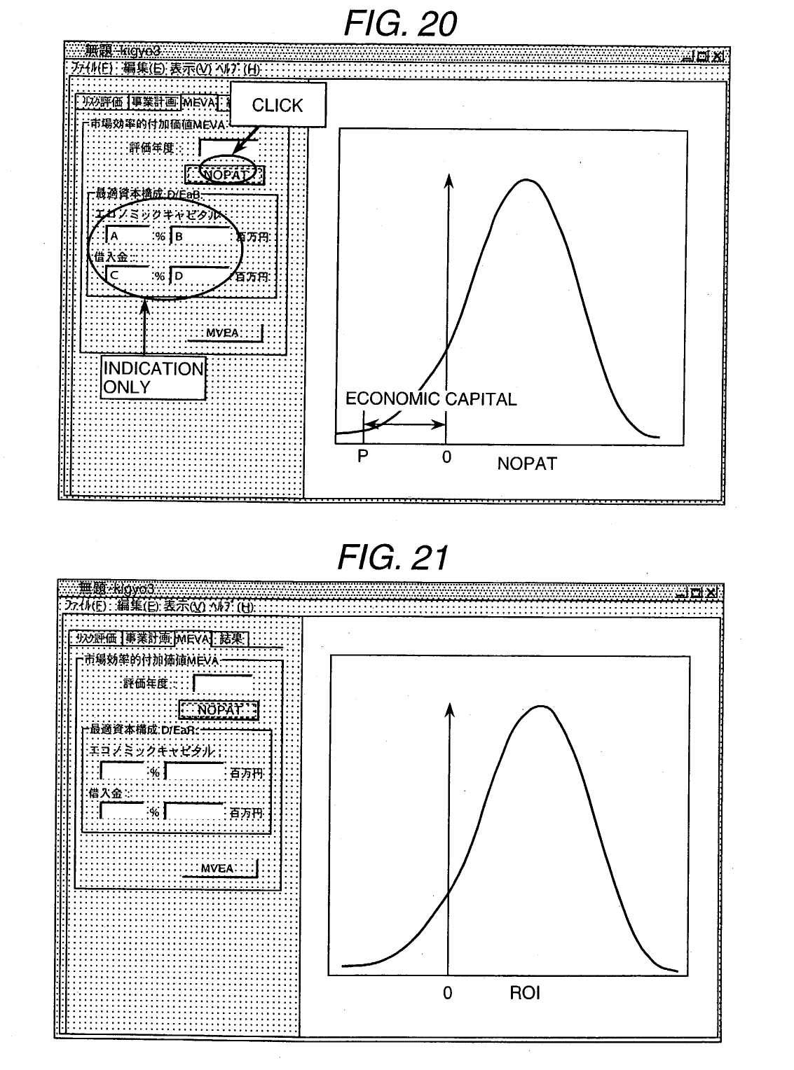

That is, selecting (clicking) the business value evaluation section C on the project analysis message screen shown in FIG. 7 displays an MEVA display screen as shown in FIG. 20. On the MEVA display screen shown in FIG. 20, an evaluation year, for example, “fiscal year 2000”, is entered and “NOPAT” is selected (clicked) . Then, the system automatically determines the corresponding matrix from among the 27 matrices and creates and displays an NOPAT distribution as shown on the display screen of FIG. 20. The vertical axis of the NOPAT distribution graph in FIG. 20 indicates the probability density. The indication “economic capital” in FIG. 20 indicates how much capital must be prepared for a new business, and the required amount corresponds to the distance (NOPAT) from the point at which the NOPAT is zero to the point on the negative side decided by a bankruptcy probability (the point p in the figure). The economic capital and the loan payable are displayed.

In this state, on the display menu message screen shown in FIG. 20, “NOPAT” is selected (clicked) and a value for “evaluation year” is entered. Then, a distribution curve as shown in FIG. 20 is displayed based on data of estimation errors δ stored in the “NOPAT-to-invested-capital ratio estimation error” database. The distribution curve shown in FIG. 20 is obtained as follows. Based on an asset scale, profitability, and a business type entered on the screen, an error histogram is selected from among the 27 error histograms stored in the “NOPAT-to-invested-capital ratio estimation error” database; the unit on the horizontal axis of the histogram is multiplied by an amount of invested capital entered on the screen; and the “0” point of the resultant histogram is overlapped on the estimated NOPAT value. The asset scale and profitability for the distribution curve shown in FIG. 20 are obtained from the values of the corresponding items in the balance sheets shown in FIG. 17 and the income statements shown in FIG. 18, respectively. The business type is obtained from the value of the new business type code field on the business plan input message screen shown in FIG. 19. Therefore, it is possible to obtain a distribution curve as shown in FIG. 20 by selecting (clicking) “NOPAT distribution” and entering an evaluation year on the display menu message screen shown in FIG. 20.

In the distribution curve shown in FIG. 20, the horizontal axis indicates the NOPAT, and the vertical axis indicates the probability density. The area of the portion enclosed by the horizontal axis and the distribution curve is set to be 1. The area of the portion enclosed by the vertical and horizontal lines intersecting with each other at the point p and the end portion of the distribution curve on the negative side indicates the default ratio (bankruptcy probability). The bankruptcy probability corresponds to the rating entered on the business plan input message screen shown in FIG. 19. Each combination of a rating and a bankruptcy probability is stored in a memory of the processing unit as a table, and therefore the default ratio (bankruptcy probability) is decided by the rating. The distance (NOPAT) from the “0” point of the distribution curve to the point p is referred to as “economic capital”, which indicates how much capital must be prepared for a new business. After a distribution curve as shown in FIG. 20 was obtained, selecting (clicking) “Back” on the business value evaluation message screen ends the processing for the business value evaluation section C (indicated by the processing flowchart C of FIG. 6 for evaluating the value of an investment-target enterprise) on the project analysis message screen shown in FIG. 7, returning the screen to the project analysis message screen shown in FIG. 7.

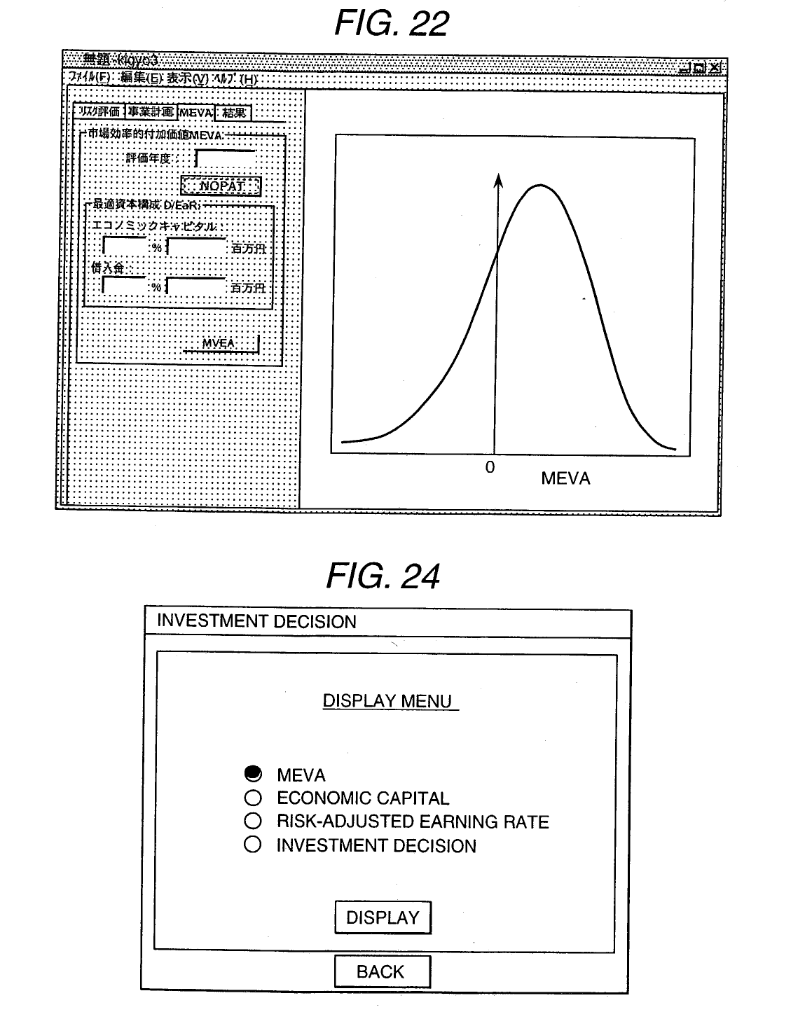

On the MEVA display screen shown in FIG. 21, an evaluation year, for example, “fiscal year 2000” is entered and “ROI” is selected (clicked), which is a business risk (return distribution). Then, an ROI distribution as shown on the display screen in FIG. 21 is created and displayed. The vertical axis of the ROI distribution graph shown in FIG. 21 indicates the probability density.

Selecting (clicking) “MEVA” on the business value evaluation message screen shown in FIG. 20 or 21 displays a display screen for indicating the MEVA as shown in FIG. 22.

Here, MEVA is obtained by the following formula:

MEVA=NOPAT (or after-tax operating profit)−WACC×C, (10)

where C denotes invested capital and WACC denotes weighted average capital cost. The item WACC×C is obtained by the following formula:

WACC×C={(economic capital/invested capital)×capital cost+(1−economic capital/invested capital)×borrowing rate×(1−tax rate)}×(shareholders' equity+loan payable) (11)

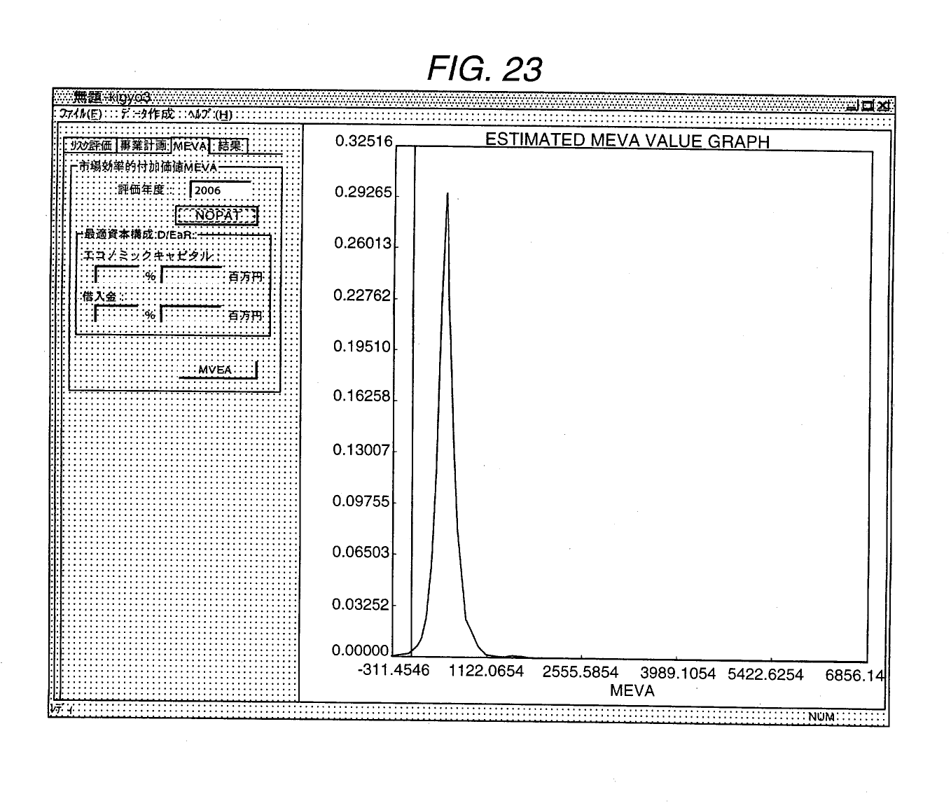

An example of the MEVA (curve) is shown on the display screen in FIG. 23. The horizontal axis indicates the amount of money, while the vertical axis indicates the probability density.

Then, investment decision processing on the desired future business plan is carried out. Specifically, the investment decision section D is selected (clicked) on the project analysis message screen shown in FIG. 7. Selecting (clicking) the investment decision section D on the project analysis message screen in FIG. 7 executes the processing flowchart D of FIG. 6 for making an investment decision. Specifically, selecting (clicking) the investment decision section D on the project analysis message screen in FIG. 7 displays a display menu message screen as shown in FIG. 24. On the display menu message screen shown in FIG. 24 are the indications (radio buttons) “MEVA”, “Economic Capital”, “Risk-Adjusted Earning Rate”, and “Investment Decision”. One of them can be selected (clicked). The risk-adjusted earning rate is expressed as the ratio of the MEVA to the economic capital.

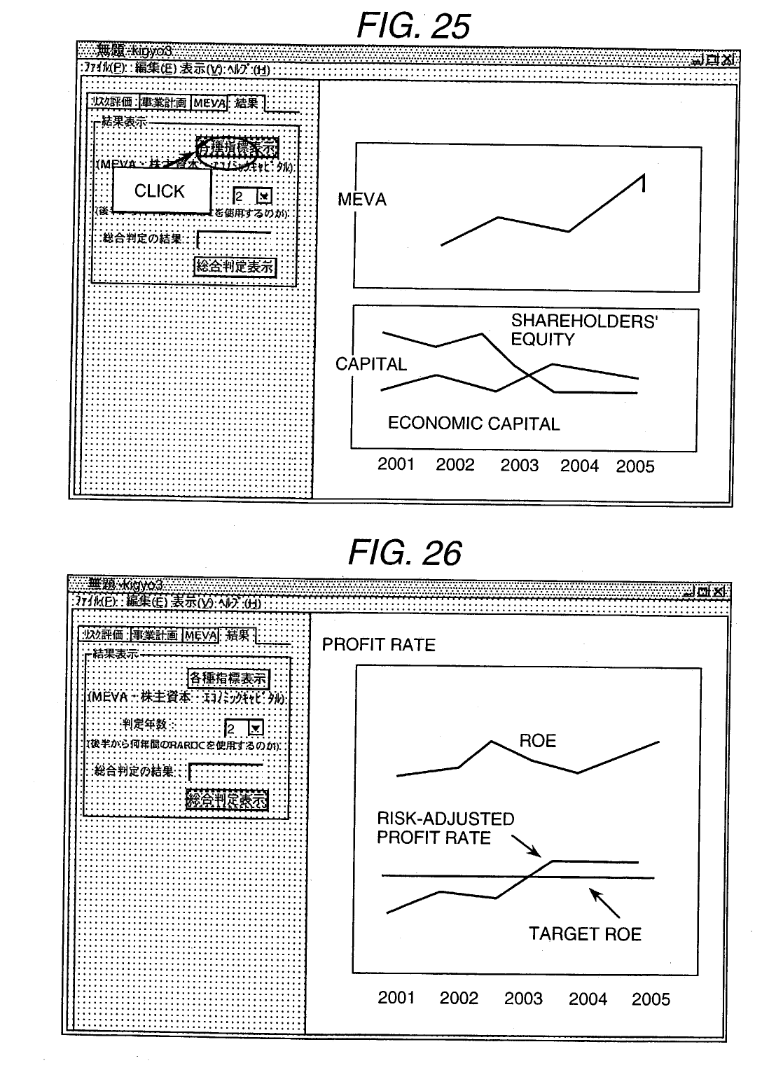

On the display menu message screen shown in FIG. 24, selecting (clicking) “MEVA” and “Economic Capital” displays an MEVA and investment decision message screen as shown in FIG. 25. An economic capital curve and a shareholders' equity curve, which is provided for reference, are displayed below on the screen. After viewing the MEVA curve and the economic capital curve, select (click) “Back” on the MEVA and investment decision message screen shown in FIG. 25 to return to the display menu message screen in FIG. 24. Then, selecting (clicking) “Risk-Adjusted Earning Rate” displays an investment decision message screen indicating a risk-adjusted earning rate curve as shown in FIG. 26. FIG. 26 indicates the risk-adjusted earning rate such that it can be compared with an ROE characteristic and a target ROE characteristic. In FIG. 26, the risk-adjusted earning rate curve exceeds the target ROE curve in 2003 and the subsequent years.

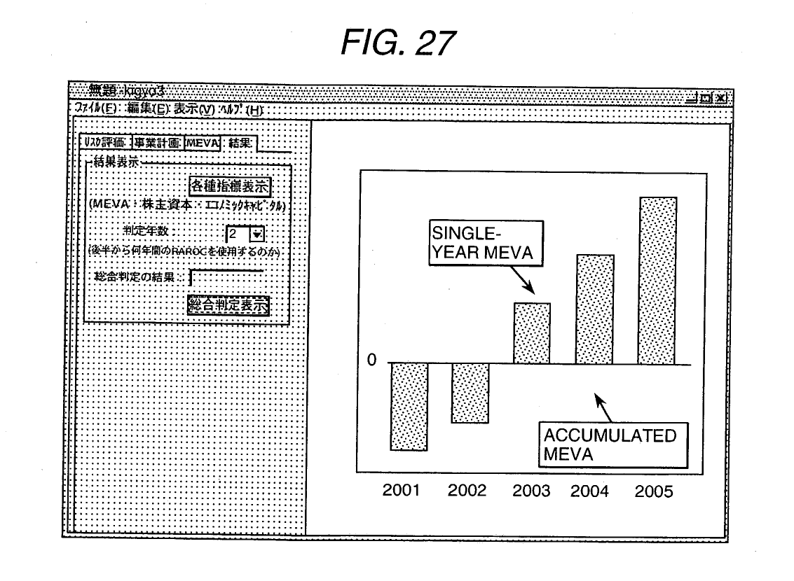

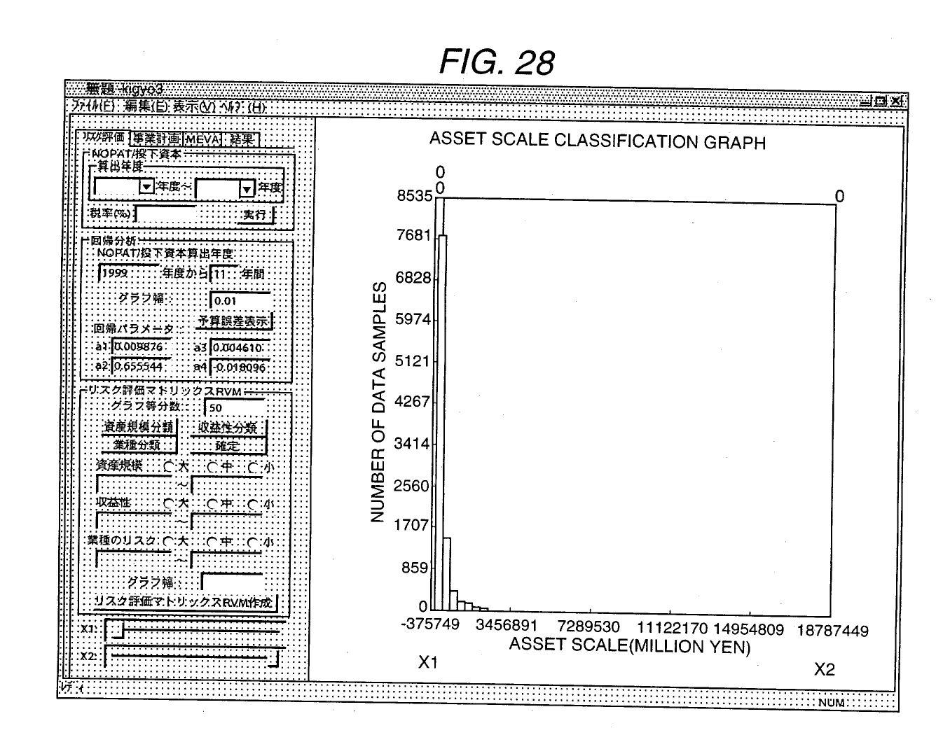

FIG. 27 shows the MEVA or accumulated MEVA for each year such that they can be compared to one another. Specifically, the figure indicates the single-year MEVA for the year 2001 and the accumulated MEVA for the subsequent years (for example, the single-year MEVA for 2001 and that for 2002 are added together to produce the accumulated MEVA for 2002). Thus, by checking the single-year MEVA or the accumulated MEVA for each year, it is possible to obtain a guideline for determining whether to expand or start a business.

As described above, the processing system according to the present invention for providing an MEVA (market efficiency value added) provides an evaluation value which makes it possible to: relate the management of business performances with the incentives within a company; include risk (uncertainty) evaluation into the investment and withdrawal guideline; appropriately create a business portfolio (selection and concentration); make the invested capital/debt structure (fundraising) appropriate; and thereby cause the company to continuously grow in harmony with the society.

Furthermore, according to the processing system of the present invention for providing an MEVA, it is possible to: vitalize operations within a company; determine investment or withdrawal for each operating department to concentrate on target businesses; carry out appropriate financial management; and thereby cause the company to continuously grow in harmony with the society.

What is claimed is:

1. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
whereby said processing system sets an MEVA evaluation period to indicate an MEVA based on an after-tax operating profit of each business operation.

2. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
whereby said processing system sets an MEVA evaluation period and a graph width to indicate an after-tax operating profit of each business operation with said set graph width.

3. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
whereby said processing system provides indications each based on a condition determined according to one of asset scale classification, profitability classification, and business type classification of all enterprises for an MEVA evaluation period.

4. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
whereby said processing system indicates a value of an estimation error in profitability for each fiscal year for an entire planned period.

5. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
wherein said processing system receives and processes a new business type code, a target ROE, a rating, a capital cost, and a borrowing rate.

6. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
wherein said processing system receives and processes a short-term loan payable, a long-term loan payable, owners' equity, and assets.

7. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
wherein said processing system receives and processes a before-tax ordinary profit, interest expense, a tax rate, and net profit.

8. A processing system for a market efficiency value added (MEVA), causing a computer to perform the operations for:
obtaining a capital composition by use of a bankruptcy probability based on a distribution of ratios of earnings to amounts of invested money;
obtaining a capital cost ratio based on said capital composition, a debt cost, and a shareholders' equity cost; and
obtaining an MEVA from said capital cost ratio based on an after-tax operating profit;
whereby said processing system indicates an MEVA for each single fiscal year for an entire planned period and further indicates an accumulated MEVA for each fiscal year for said entire planned period.
